(19) United States
(12) Patent Application Publication
(10) Pub. No.: US 2019/0279089 A1
(43) Pub. Date: Sep. 12, 2019

(54) METHOD AND APPARATUS FOR NEURAL NETWORK PRUNING

(71) Applicant: TUSIMPLE, INC., San Diego, CA (US)

(72) Inventor: Naiyan Wang, Beijing (CN)

(21) Appl. No.: 16/416,142

(22) Filed: May 17, 2019

Related U.S. Application Data
(63) Continuation of application No. PCT/CN2017/102029, filed on Sep. 18, 2017.

(30) Foreign Application Priority Data
Nov. 17, 2016 (CN) 201611026107.9

(51) Int. Cl. G06N 3/08; G06F 17/16; G06N 3/04

(52) U.S. Cl. CPC G06N 3/082; G06N 3/04; G06F 17/16

(57) ABSTRACT

The present disclosure provides a method and an apparatus for neural network pruning, capable of solving the problem in the related art that compression, acceleration and accuracy cannot be achieved at the same time in network pruning. The method includes: determining (101) importance values of neurons in a network layer to be pruned based on activation values of the neurons; determining (102) a diversity value of each neuron in the network layer to be pruned based on connecting weights between the neuron and neurons in a next network layer; selecting (103), from the network layer to be pruned, neurons to be retained based on the importance values and diversity values of the neurons in the network layer to be pruned in accordance with a volume maximization neuron selection policy; and pruning (104) the other neurons from the network layer to be pruned to obtain a pruned network layer. With the above method, good compression and acceleration effects can be achieved while maintaining the accuracy of the neural network.

### CROSS REFERENCE TO RELATED APPLICATIONS

The present disclosure claims priority to Chinese Patent Application No. 201611026107.9, titled “METHOD AND APPARATUS FOR NEURAL NETWORK PRUNING”, filed on Nov. 17, 2016, the content of which is incorporated herein by reference in its entirety.

### TECHNICAL FIELD

The present disclosure relates to computer technology, and more particularly, to a method and an apparatus for neural network pruning.

### BACKGROUND

Currently, deep neural networks have achieved enormous success in computer vision technology, such as image classification, target detection, image segmentation and the like. However, a deep neural network having a better performance typically has a larger number of model parameters, resulting in a larger amount of computation and a larger space occupied by models in an actual deployment, which prevents it from being normally applied to application scenarios requiring real-time computation. Thus, how to compress and accelerate deep neural networks becomes particularly important, especially for some future application scenarios where the deep neural networks need to be applied in e.g., embedded devices or integrated hardware devices.

Currently, deep neural networks are compressed and accelerated mainly by means of network pruning. For example, a weight-based network pruning technique has been proposed in Song Han, et al., Learning both Weights and Connections for Efficient Neural Network, and a neural network pruning technique based on determinantal point process has been proposed in Zelda Mariet, et al., Diversity Networks. However, the existing network pruning techniques cannot achieve ideal effects, e.g., they cannot achieve compression, acceleration and accuracy at the same time.

### SUMMARY

In view of the above problem, the present disclosure provides a method and an apparatus for neural network pruning, capable of solving the problem in the related art that compression, acceleration and accuracy cannot be achieved at the same time.

In an aspect of the present disclosure, a method for neural network pruning is provided. The method includes: determining importance values of neurons in a network layer to be pruned based on activation values of the neurons; determining a diversity value of each neuron in the network layer to be pruned based on connecting weights between the neuron and neurons in a next network layer; selecting, from the network layer to be pruned, neurons to be retained based on the importance values and diversity values of the neurons in the network layer to be pruned in accordance with a volume maximization neuron selection policy; and pruning the other neurons from the network layer to be pruned to obtain a pruned network layer.

In another aspect, according to an embodiment of the present disclosure, an apparatus for neural network pruning is provided. The apparatus includes: an importance value determining unit configured to determine importance values of neurons in a network layer to be pruned based on activation values of the neurons;

a diversity value determining unit configured to determine a diversity value of each neuron in the network layer to be pruned based on connecting weights between the neuron and neurons in a next network layer; a neuron selecting unit configured to select, from the network layer to be pruned, neurons to be retained based on the importance values and diversity values of the neurons in the network layer to be pruned in accordance with a volume maximization neuron selection policy; and a pruning unit configured to prune the other neurons from the network layer to be pruned to obtain a pruned network layer.

In another aspect, according to an embodiment of the present disclosure, an apparatus for neural network pruning is provided. The apparatus includes a processor and at least one memory storing at least one machine executable instruction. The processor is operative to execute the at least one machine executable instruction to: determine importance values of neurons in a network layer to be pruned based on activation values of the neurons; determine a diversity value of each neuron in the network layer to be pruned based on connecting weights between the neuron and neurons in a next network layer; select, from the network layer to be pruned, neurons to be retained based on the importance values and diversity values of the neurons in the network layer to be pruned in accordance with a volume maximization neuron selection policy; and prune the other neurons from the network layer to be pruned to obtain a pruned network layer.

With the method for neural network pruning according to the embodiment of the present disclosure, first, for each neuron in a network layer to be pruned, an importance value of the neuron is determined based on an activation value of the neuron and a diversity value of the neuron based on connecting weights between the neuron and neurons in a next network layer. Then, neurons to be retained are selected from the network layer to be pruned based on the importance values and diversity values of the neurons in the network layer to be pruned in accordance with a volume maximization neuron selection policy. In the solutions according to the present disclosure, an importance value of a neuron reflects a degree of impact the neuron has on an output result from the neural network, and a diversity of a neuron reflects its expression capability. Hence, the neurons selected in accordance with the volume maximization neuron selection policy have greater contributions to the output result from the neural network and higher expression capabilities, while the pruned neurons are neurons having smaller contributions to the output result from the neural network and lower expression capabilities. Accordingly, when compared with the original neural network, the pruned neural network may achieve good compression and acceleration effects while having little accuracy loss. Therefore, the pruning method according to the embodiment of the present disclosure may achieve good compression and acceleration effects while maintaining the accuracy of the neural network.

The other features and advantages of the present disclosure will be explained in the following description, and will become apparent partly from the description or be understood by implementing the present disclosure. The objects and other advantages of the present disclosure can be achieved and obtained from the structures specifically illustrated in the written description, claims and figures.

In the following, the solutions according to the present disclosure will be described in detail with reference to the figures and embodiments.

### BRIEF DESCRIPTION OF THE DRAWINGS

The figures are provided for facilitating further understanding of the present disclosure. The figures constitute a portion of the description and can be used in combination with the embodiments of the present disclosure to interpret, rather than limiting, the present disclosure. It is apparent to those skilled in the art that the figures described below only illustrate some embodiments of the present disclosure and other figures can be obtained from these figures without applying any inventive skills. In the figures:

FIG. 1 is a first flowchart illustrating a method for neural network pruning according to some embodiments of the present disclosure;

FIG. 2 is a flowchart illustrating a method for determining an importance value of a neuron according to some embodiments of the present disclosure;

FIG. 3 is a first flowchart illustrating a method for selecting neurons to be retained from a network layer to be pruned according to some embodiments of the present disclosure;

FIG. 4 is a second flowchart illustrating a method for selecting neurons to be retained from a network layer to be pruned according to some embodiments of the present disclosure;

FIG. 5 is a flowchart illustrating a method for selecting neurons using a greedy method according to some embodiments of the present disclosure;

FIG. 6 is a second flowchart illustrating a method for neural network pruning according to some embodiments of the present disclosure;

FIG. 7 is a third flowchart illustrating a method for neural network pruning according to some embodiments of the present disclosure;

FIG. 8 is a first schematic diagram showing a structure of an apparatus for neural network pruning according to some embodiments of the present disclosure;

FIG. 9 is a schematic diagram showing a structure of an importance value determining unit according to some embodiments of the present disclosure;

FIG. 10 is a first schematic diagram showing a structure of a neuron selecting unit according to some embodiments of the present disclosure;

FIG. 11 is a second schematic diagram showing a structure of a neuron selecting unit according to some embodiments of the present disclosure;

FIG. 12 is a second schematic diagram showing a structure of an apparatus for neural network pruning according to some embodiments of the present disclosure;

FIG. 13 is a third schematic diagram showing a structure of an apparatus for neural network pruning according to some embodiments of the present disclosure; and

FIG. 14 is a fourth schematic diagram showing a structure of an apparatus for neural network pruning according to some embodiments of the present disclosure.

### DETAILED DESCRIPTION OF THE EMBODIMENTS

In the following, the solutions according to the embodiments of the present disclosure will be described clearly and completely with reference to the figures, such that the solutions can be better understood by those skilled in the art. Obviously, the embodiments described below are only some, rather than all, of the embodiments of the present disclosure. All other embodiments that can be obtained by those skilled in the art based on the embodiments described in the present disclosure without any inventive efforts are to be encompassed by the scope of the present disclosure.

The core idea of the present disclosure has been described above. The solutions according to the embodiments of the present disclosure will be described in further detail below with reference to the figures, such that they can be better understood by those skilled in the art and that the above objects, features and advantages of the embodiments of the present disclosure will become more apparent.

The solutions according to the present disclosure, when applied, may determine which network layers (referred to as network layers to be pruned hereinafter) in a neural network need to be pruned depending on actual requirements. Some or all of the network layers in the neural network may be pruned. In practice, for example, it may be determined whether to prune a network layer based on an amount of computation for the network layer. Further, the number of network layers to be pruned and the number of neurons to be pruned in each network layer to be pruned may be determined based on a tradeoff between the speed and accuracy required for the pruned neural network (e.g., the accuracy of the pruned neural network shall not be lower than 90% of the accuracy before pruning). The number of neurons to be pruned may or may not be the same for different network layers to be pruned, and may be selected by those skilled in the art flexibly depending on requirements of actual applications. The present disclosure is not limited to any specific number.

FIG. 1 is a flowchart illustrating a method for neural network pruning according to some embodiments of the present disclosure. The method shown in FIG. 1 may be applied to each network layer to be pruned in a neural network. The method includes the following steps.

At step 101, importance values of neurons in a network layer to be pruned are determined based on activation values of the neurons.

At step 102, a diversity value of each neuron in the network layer to be pruned is determined based on connecting weights between the neuron and neurons in a next network layer.

At step 103, neurons to be retained is selected from the network layer to be pruned based on the importance values and diversity values of the neurons in the network layer to be pruned in accordance with a volume maximization neuron selection policy.

At step 104, the other neurons are pruned from the network layer to be pruned to obtain a pruned network layer.

In the following, specific implementations of the respective steps in the above method shown in FIG. 1 will be described in detail, such that the solution according to the present disclosure can be better understood by those skilled in the art. The specific implementations are exemplary only. Other alternatives or equivalents can be contemplated by those skilled in the art from these examples and these alternatives or equivalents are to be encompassed by the scope of the present disclosure.

In some embodiments of the present disclosure, the following description will be given with reference to an example where the network layer to be pruned is the l-th layer in the neural network.

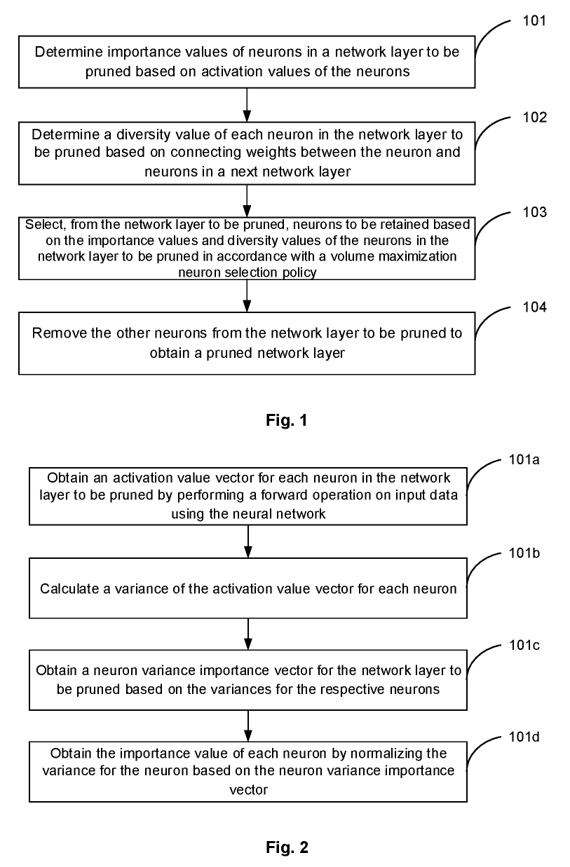

Preferably, the above step 101 may be implemented according to the method shown in FIG. 2, which includes the following steps.

At step 101a, an activation value vector for each neuron in the network layer to be pruned is obtained by performing a forward operation on input data using the neural network.

At step 101b, a variance of the activation value vector for each neuron is calculated.

At step 101c, a neuron variance importance vector for the network layer to be pruned is determined based on the variances for the respective neurons.

At step 101d, the importance value of each neuron is determined by normalizing the variance for the neuron based on the neuron variance importance vector.

It is assumed that the network layer to be pruned is the l-th layer in the neural network, the network layer to be pruned includes a total number nₗ of neurons, training data for the neural network is T=[t₁,t₂, . . . , t_{N}], and dᵢⱼ^{l} a denotes an activation value of the i-th neuron in the l-th layer when input data is tⱼ, where 1≤i≤nₗ and 1≤j≤N.

According to the above step 101a, the activation value vector for each neuron in the network layer to be pruned may be obtained as:

vᵢ^{l}=(aᵢ₁^{l},aᵢ₂^{l}, . . . ,a_{iN}^{l}) (1)

where vᵢ^{l} denotes the activation value vector for the i-th neuron in the network layer to be pruned.

According to the above step 101b, the variance of the activation value vector for each neuron may be calculated as:

qᵢ^{l}=Var(vᵢ^{l}) (2)

where qᵢ^{l} denotes the variance of the activation value vector for the i-th neuron in the network layer to be pruned.

According to the above step 101c, the neuron variance importance vector may be obtained as Q^{l}=[q₁^{l}, q₂^{l}, . . . qₙ_{ᵢ}^{l}]^{T}.

According to the above step 101d, the variance for each neuron may be normalized as:

$${q}_{i}^{l} = \frac{{q}_{i}^{l} - min ( {Q}^{l} )}{max ( {Q}^{l} ) - min ( {Q}^{l} )} \qquad ( 3 )$$

where qᵢ^{l} denotes the variance of the activation value vector for the i-th neuron in the network layer to be pruned, and Q^{l} denotes the neuron variance importance vector for the network layer to be pruned.

In some embodiments of the present disclosure, when the variance of the activation value vector for a neuron is small, it indicates that the activation value of the neuron does not vary significantly for different input data (e.g., when the activation value of the neuron is always 0, it indicates that the neuron has no impact on the output result from the network). That is, a neuron having a smaller variance of its activation value vector has a smaller impact on the output result from the neural network, and on the other hand, a neuron having a larger variance of its activation value vector has a larger impact on the output result from the neural network. Hence, the variance of the activation value vector for a neuron may reflect the importance of the neuron to the neural network. If the activation value of a neuron is always maintained at a non-zero value, the neuron may be fused into another neuron.

Of course, according to the present disclosure, the importance value for a neuron is not limited to the variance of the activation value vector for the neuron. It can be appreciated by those skilled in the art that the importance of a neuron may be represented by the mean value, standard deviation or gradient mean value of the activation values for the neuron, and the present disclosure is not limited to any of these.

Preferably, in some embodiments of the present disclosure, the above step 102 may be implemented by: creating, for each neuron in the network layer to be pruned, a weight vector for the neuron based on the connecting weights between the neuron and the neurons in the next network layer, and determining a direction vector of the weight vector as the diversity value of the neuron.

The weight vector for each neuron may be created as:

Wᵢ^{l}=[wᵢ₁^{l},wᵢ₂^{l}, . . . ,wᵢₙ_{ₗ₊₁}^{l}]^{T} (4)

where Wᵢ^{l} denotes the weight vector for the i-th neuron in the network layer to be pruned, wᵢⱼ^{l} denotes the connecting weight between the i-th neuron in the network layer to be pruned and the j-th neuron in the next network layer (i.e., the (l+1)-th layer), and nₗ₊₁ denotes the total number of neurons included in the (l+1)-th layer, where 1≤j≤ₗ₊ₗ.

The direction vector of the weight vector for each neuron may be represented as:

$${φ}_{i}^{l} = \frac{{W}_{i}^{l}}{{‖ {W}_{i}^{l} ‖}_{2}} .$$

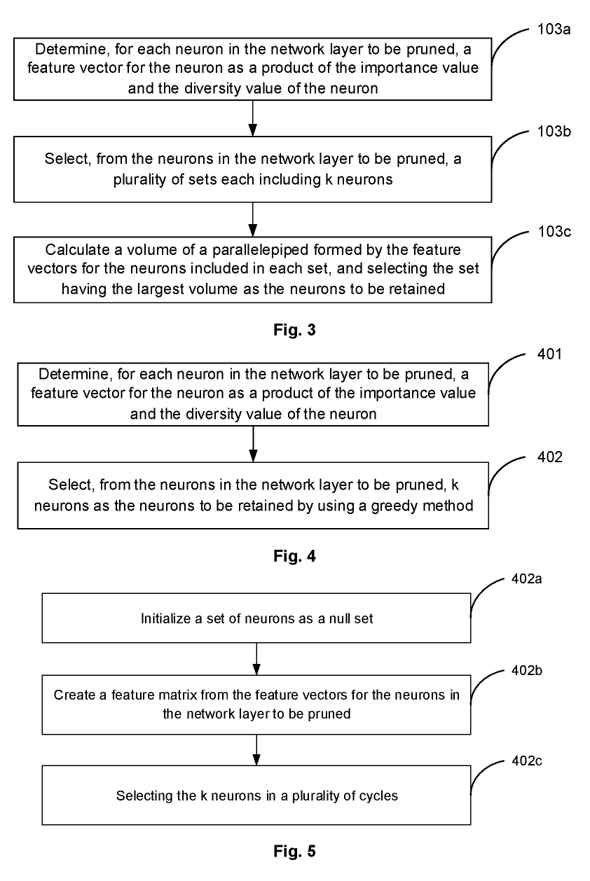

Preferably, in some embodiments of the present disclosure, the above step 103 may be implemented according to the method shown in FIG. 3 or FIG. 4.

FIG. 3 shows a method for selecting neurons to be retained from a network layer to be pruned according to some embodiments of the present disclosure. As shown, the method includes the following steps.

At step 103a, for each neuron in the network layer to be pruned, a product of the importance value and the diversity value of the neuron is determined as a feature vector for the neuron.

In some embodiments of the present disclosure, the feature vector for each neuron may be determined as:

bᵢ^{l}=qᵢ^{l}ϕᵢ^{l} (6)

where bᵢ^{l} denotes the feature vector for the i-th neuron in the network layer to be pruned.

At step 103b, a plurality of sets each including k neurons are selected from the neurons in the network layer to be pruned, where k is a predetermined positive integer.

Preferably, in order to compare as many sets as possible, each set including k neurons, so as to make sure that the neurons finally selected to be retained are optimal, in some embodiments of the present disclosure, Cₙ_{ₗ}^{k}^{ₗ} sets may be selected in the above step 103b, where nₗ denotes the total number of neurons in the network layer to be pruned and kₗ denotes the number of neurons determined to be retained, i.e., the above k.

At step 103c, a volume of a parallelepiped formed by the feature vectors for the neurons included in each set is calculated, and the set having the largest volume is selected as the neurons to be retained.

Once the feature vectors for the neurons have been obtained, a similarity between two neurons may be measured by a cosine value of the angle θᵢⱼ between them, i.e., cos θᵢⱼ^{l}= [symbol] ϕᵢ^{l}, ϕⱼ^{l} [symbol] =ϕᵢ^{l}^{^{T}} ϕⱼ^{l}. A greater value of cos θᵢⱼ^{l} indicates a higher similarity between the i-th and the j-th neurons in the network layer to be pruned. For example, the i-th and the j-th neurons are identical when cos θᵢⱼ^{l}=1. On the other hand, a smaller value of cos θᵢⱼ^{l} indicates a lower similarity between the i-th and the j-th neurons and thus a greater diversity of the set consisting of the two neurons. According to this principle, by selecting neurons having higher importance values and lower similarities, the set consisting of the selected neurons may have a greater diversity. For example, two neurons having a larger qᵢ^{l}*qⱼ^{l} value and a smaller cos θᵢⱼ^{l} value may be selected. To facilitate optimization, cos θᵢⱼ^{l} may be replaced with sin θᵢⱼ^{l}, and qᵢ^{l}*qⱼ^{l}*sin θᵢⱼ^{l} is to be maximized. To maximize qᵢ^{l}*qⱼ^{l}*sin θᵢⱼ^{l} is to maximize the area of the parallelogram formed by two respective vectors bᵢ^{l} and bⱼ^{l} of the i-th and the j-th neurons. This principle may be generalized to be applied to selection of k neurons, which becomes a MAX-VOL problem, i.e., to find a sub-matrix Cₗ∈ [symbol] ⁿ^{ₗ₊₁}^{×k}^{ₗ} in the matrix B^{l}=[b₁^{l}, b₂^{l}, . . . , bₙ_{ₗ}^{l}] such that the volume of the parallelepiped formed by the k vectors may be maximized.

FIG. 4 shows a method for selecting neurons to be retained from a network layer to be pruned according to some embodiments of the present disclosure. As shown, the method includes the following steps.

At step 401, for each neuron in the network layer to be pruned, a product of the importance value and the diversity value of the neuron is determined as a feature vector for the neuron.

The details of the above step 401, reference can be made to the above described step 301 and description thereof will be omitted.

At step 402, k neurons are selected from the neurons in the network layer to be pruned as the neurons to be retained by using a greedy method.

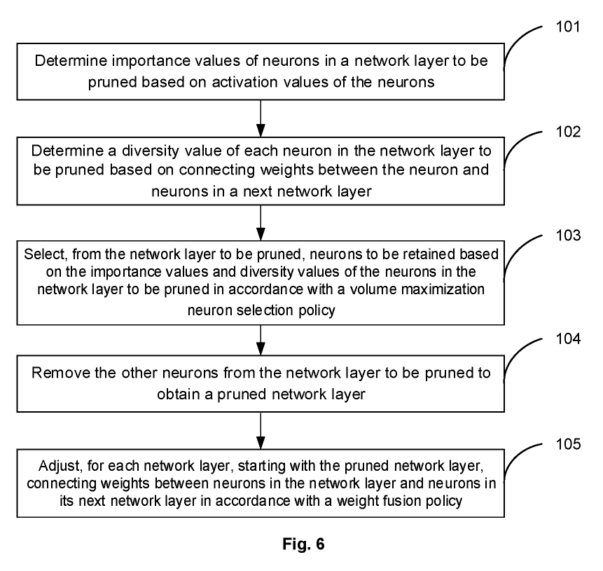

In some embodiments, the above step 402 of selecting the neurons by using the greed method may be implemented according to the method shown in FIG. 5, which includes the following steps.

At step 402a, a set of neurons is initialized as a null set C.

At step 402b, a feature matrix is created from the feature vectors for the neurons in the network layer to be pruned.

In some embodiments of the present disclosure, the created feature matrix may be B^{l}=[b₁^{l}, b₂^{l}, . . . , bₙ_{ₗ}^{l}], is the feature matrix and bᵢ^{l} is the feature vector for the i-th neuron in the l-th layer.

At step 402c, the k neurons are selected by performing the following steps in a plurality of cycles:

selecting, from a feature matrix B^{l} for a current cycle of selection, a feature vector bᵢ^{l} having the largest length, and adding the neuron corresponding to the feature vector bᵢ^{l} having the largest length to the set C of neurons; and

determining whether a number of neurons in the set of neurons has reached k, and if so, terminating the cycles; or otherwise removing, from the feature matrix B^{l} selected in the current cycle, a projection of the feature vector having the largest length onto each of the other feature vectors, to obtain a feature matrix B^{l} for a next cycle of selection and proceeding with the next cycle.

In the solutions according to the present disclosure, an importance value of a neuron reflects a degree of impact the neuron has on an output result from the neural network, and a diversity of a neuron reflects its expression capability. Hence, the neurons selected in accordance with the volume maximization neuron selection policy have greater contributions to the output result from the neural network and higher expression capabilities, while the pruned neurons are neurons having smaller contributions to the output result from the neural network and lower expression capabilities. Accordingly, when compared with the original neural network, the pruned neural network may achieve good compression and acceleration effects while having little accuracy loss. Therefore, the pruning method according to the embodiments of the present disclosure may achieve good compression and acceleration effects while maintaining the accuracy of the neural network.

There will be an accuracy loss after the network layer to be pruned is pruned. Hence, preferably, in order to improve the accuracy of the pruned neural network, in some embodiments of the present disclosure, after the network layer to be pruned is pruned, connecting weights between the neurons in the pruned network layer and the neurons in the next network layer are adjusted in accordance with a weight fusion policy. Further, after the weight fusion, activation values obtained for the next network layer of the pruned network layer may be different from those before the pruning and there will be some errors. When the pruned network layer is at a shallow level of the neural network, such errors may be accumulated in operations in subsequent network layers. Hence, in order to further improve the accuracy of the neural network, in some embodiments of the present disclosure, for each network layer subsequent to the pruned network layer, connecting weights between neurons in the network layer and neurons in its next network layer are adjusted.

Thus, the above step 104 as shown in FIG. 1 may be followed by step 105 as shown in FIG. 6.

At step 105, for each network layer, starting with the pruned network layer, connecting weights between neurons in the network layer and neurons in its next network layer are adjusted in accordance with a weight fusion policy.

In some embodiments, the connecting weights between the neurons in each network layer and the neurons in its next network layer may be adjusted in accordance with the weight fusion policy as follows.

1) For the pruned network layer, the connecting weights between the neurons in the pruned network layer (i.e., the l-th layer) and the neurons in its next network layer (i.e., the (l+1)-th layer) may be obtained as:

\tilde{w}ᵢⱼ^{l}=δᵢⱼ^{l}+wᵢⱼ^{l} (7)

where \tilde{w}ᵢⱼ^{l} denotes the adjusted connecting weight between the i-th neuron in the l-th layer and the j-th neuron in the (l+1)-th layer, δᵢⱼ^{l} denotes a fusion delta, and wᵢⱼ^{l} denotes the connecting weight between the i-th neuron in the l-th layer and the j-th neuron in the (l+1)-th layer before the adjusting.

\tilde{w}ᵢⱼ^{l} may be obtained by solving the following equation:

$${min}_{{\tilde{w}}_{ij}^{l}} {‖ {\sum }_{i = 1}^{{k}_{l}} {\tilde{w}}_{ij}^{l} {v}_{i}^{l} - {\sum }_{i = 1}^{{n}_{l}} {w}_{ij}^{l} {v}_{i}^{l} ‖}_{2} = {min}_{{δ}_{ij}^{l}} {‖ {\sum }_{i = 1}^{{k}_{l}} {δ}_{ij}^{l} {v}_{i}^{l} - {\sum }_{i = {k}_{l} + 1}^{{n}_{l}} {w}_{ij}^{l} {v}_{i}^{l} ‖}_{2}$$

The result of the solution is:

∀i,1≤i≤kₗ,\tilde{w}ᵢⱼ^{l}=wᵢⱼ^{l}+Σᵣ₌ₖ_{ₗ}₊₁ⁿ^{ₗ}αᵢᵣ^{l}wᵣⱼ^{l}

where aᵢᵣ^{l} is the Least Square solution of

$${min}_{{α}_{ir}^{l}} {‖ {v}_{j}^{l} - {\sum }_{i = 1}^{{k}_{l}} {α}_{ij}^{l} {v}_{i}^{l} ‖}_{2} , j > k .$$

2) For each network layer subsequent to the pruned network layer, the connecting weights between the neurons in the network layer and the neurons in its next network layer may be obtained as:

\tilde{w}ᵢⱼ^{k}=δᵢⱼ^{k}+wᵢⱼ^{k}, for k>l (8)

where \tilde{w}ᵢⱼ^{k} denotes the adjusted connecting weight between the i-th neuron in the k-th layer and the j-th neuron in the (k+1)-th layer, δᵢⱼ^{k} denotes a fusion delta, and wᵢⱼ^{k} denotes the connecting weight between the i-th neuron in the k-th layer and the j-th neuron in the (k+1)-th layer before the adjusting.

\tilde{w}ᵢⱼ^{k} may be obtained by solving the following equation:

$${min}_{{\tilde{w}}_{ij}^{k}} {‖ {\sum }_{i = 1}^{{n}_{k}} {\tilde{w}}_{ij}^{k} {v}_{i}^{′ k} - {\sum }_{i = 1}^{{n}_{k}} {w}_{ij}^{k} {v}_{i}^{k} ‖}_{2} = {min}_{{δ}_{ij}^{k - 1}} {‖ {\sum }_{i = 1}^{{n}_{k}} {δ}_{ij}^{k} {v}_{i}^{′ k} - {\sum }_{i = 1}^{{n}_{k}} {w}_{ij}^{k} ( {v}_{i}^{′ k} - {v}_{i}^{k - 1} ) ‖}_{2}$$

where v′ₗ^{k} denotes the activation value vector for the i-th neuron in the k-th layer after the adjusting, and vᵢ^{k} denotes the activation value vector for the i-th neuron in the k-th layer before the adjusting.

δᵢⱼ^{k} may be obtained by means of Least Square method. The principle has been described above and details thereof will be omitted here.

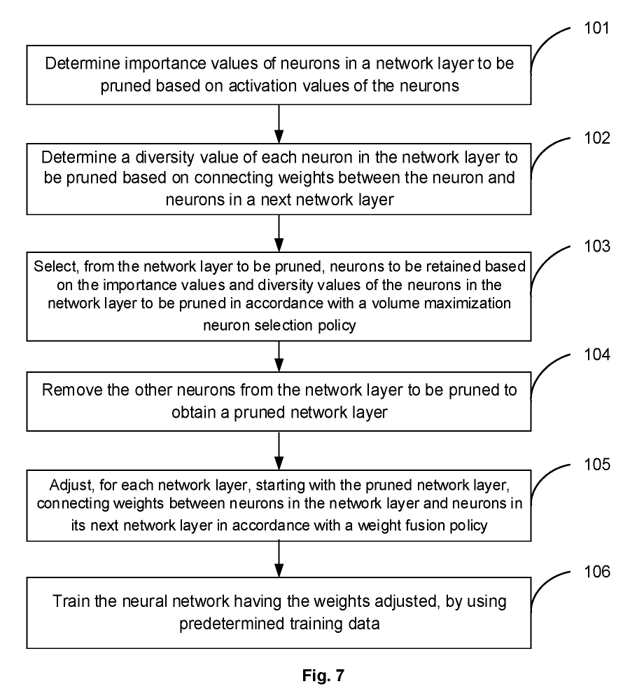

Preferably, in order to further improve the accuracy of the pruned neural network, in some embodiments of the present disclosure, the method shown in FIG. 6 may further include step 106, as shown in FIG. 7.

At step 106, the neural network having the weights adjusted is trained by using predetermined training data.

In some embodiments of the present disclosure, any existing training scheme in the related art may be used for training the neural network having the weights adjusted and details thereof will be omitted here. In some embodiments of the present disclosure, the neural network having the weights adjusted may be used as an initial network model which can be re-trained based on original training data T at a low learning rate, so as to further improve the network accuracy of the pruned neural network.

In some embodiments of the present disclosure, the above steps 105 and 106 may be performed after certain network layer to be pruned in the neural network has been pruned, and then the pruning operation on the next network layer to be pruned may be performed based on the neural network trained in the step 106.

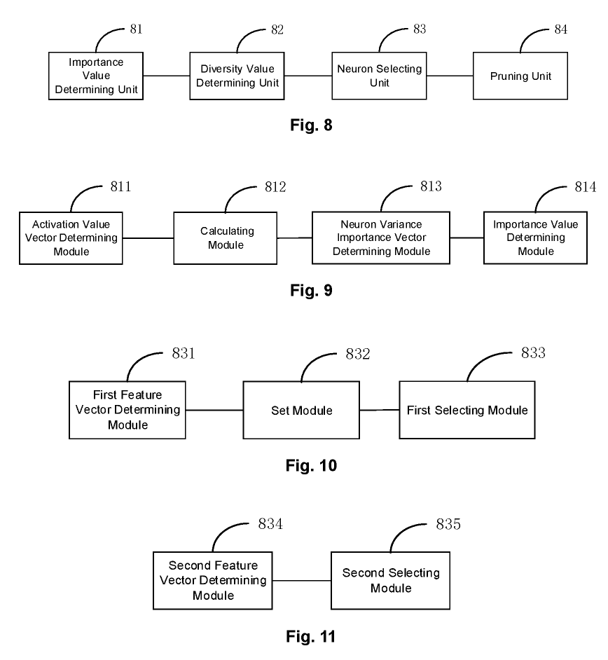

Based on the same concept as the above method, an apparatus for neural network pruning is provided according to some embodiment of the present disclosure. The apparatus has a structure shown in FIG. 8 and includes the following units.

An importance value determining unit 81 may be configured to determine importance values of neurons in a network layer to be pruned based on activation values of the neurons.

A diversity value determining unit 82 may be configured to determine a diversity value of each neuron in the network layer to be pruned based on connecting weights between the neuron and neurons in a next network layer.

A neuron selecting unit 83 may be configured to select, from the network layer to be pruned, neurons to be retained based on the importance values and diversity values of the neurons in the network layer to be pruned in accordance with a volume maximization neuron selection policy.

A pruning unit 84 may be configured to prune the other neurons from the network layer to be pruned to obtain a pruned network layer.

Preferably, the importance value determining unit 81 may have a structure shown in FIG. 9 and include the following modules.

An activation value vector determining module 811 may be configured to obtain an activation value vector for each neuron in the network layer to be pruned by performing a forward operation on input data using the neural network.

A calculating module 812 may be configured to calculate a variance of the activation value vector for each neuron.

A neuron variance importance vector determining module 813 may be configured to obtain a neuron variance importance vector for the network layer to be pruned based on the variances for the respective neurons.

An importance value determining module 814 may be configured to obtain the importance value of each neuron by normalizing the variance for the neuron based on the neuron variance importance vector.

Preferably, the diversity value determining unit 82 may be configured to: create, for each neuron in the network layer to be pruned, a weight vector for the neuron based on the connecting weights between the neuron and the neurons in the next network layer, and determine a direction vector of the weight vector as the diversity value of the neuron.

Preferably, the neuron selecting unit 83 may have a structure shown in FIG. 10 and include the following modules.

A first feature vector determining module 831 may be configured to determine, for each neuron in the network layer to be pruned, a product of the importance value and the diversity value of the neuron as a feature vector for the neuron.

A set module 832 may be configured to select, from the neurons in the network layer to be pruned, a plurality of sets each including k neurons, where k is a predetermined positive integer.

A first selecting module 833 may be configured to calculate a volume of a parallelepiped formed by the feature vectors for the neurons included in each set, and select the set having the largest volume as the neurons to be retained.

Preferably, the neuron selecting unit 83 may have another structure shown in FIG. 11 and include the following modules.

A second feature vector determining module 834 may be configured to determine, for each neuron in the network layer to be pruned, a product of the importance value and the diversity value of the neuron as a feature vector for the neuron.

A second selecting module 835 may be configured to select, from the neurons in the network layer to be pruned, k neurons as the neurons to be retained by using a greedy method.

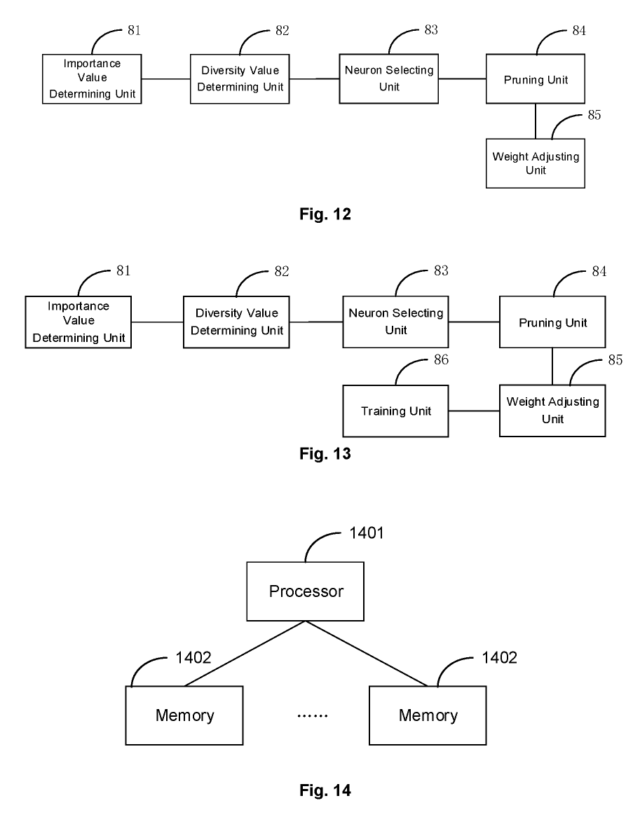

Preferably, in some embodiments of the present disclosure, the apparatus shown in each of FIGS. 8-11 may further include a weight adjusting unit 85. As shown in FIG. 12, the apparatus of FIG. 8 may include the weight adjusting unit 85.

The weight adjusting unit 85 may be configured to adjust, for each network layer, starting with the pruned network layer, connecting weights between neurons in the network layer and neurons in its next network layer in accordance with a weight fusion policy.

Preferably, in some embodiments of the present disclosure, the apparatus shown in FIG. 11 may further include a training unit 86, as shown in FIG. 13.

The training unit 86 may be configured to train the neural network having the weights adjusted, by using predetermined training data.

Based on the same concept as the above method, an apparatus for neural network pruning is provided according to an embodiment of the present disclosure. The apparatus has a structure shown in FIG. 14 and includes a processor 1401 and at least one memory 1402 storing at least one machine executable instruction. The processor 1401 is operative to execute the at least one machine executable instruction to: determine importance values of neurons in a network layer to be pruned based on activation values of the neurons; determine a diversity value of each neuron in the network layer to be pruned based on connecting weights between the neuron and neurons in a next network layer; select, from the network layer to be pruned, neurons to be retained based on the importance values and diversity values of the neurons in the network layer to be pruned in accordance with a volume maximization neuron selection policy; and prune the other neurons from the network layer to be pruned to obtain a pruned network layer.

Here, the processor 1401 being operative to execute the at least one machine executable instruction to determine the importance values of the neurons in the network layer to be pruned based on the activation values of the neurons may include the processor 1401 being operative to execute the at least one machine executable instruction to: obtain an activation value vector for each neuron in the network layer to be pruned by performing a forward operation on input data using the neural network; calculate a variance of the activation value vector for each neuron; obtain a neuron variance importance vector for the network layer to be pruned based on the variances for the respective neurons; and obtain the importance value of each neuron by normalizing the variance for the neuron based on the neuron variance importance vector.

Here, the processor 1401 being operative to execute the at least one machine executable instruction to determine the diversity value of each neuron in the network layer to be pruned based on the connecting weights between the neuron and the neurons in the next network layer may include the processor 1401 being operative to execute the at least one machine executable instruction to: create, for each neuron in the network layer to be pruned, a weight vector for the neuron based on the connecting weights between the neuron and the neurons in the next network layer, and determine a direction vector of the weight vector as the diversity value of the neuron.

Here, the processor 1401 being operative to execute the at least one machine executable instruction to select, from the network layer to be pruned, the neurons to be retained based on the importance values and diversity values of the neurons in the network layer to be pruned in accordance with the volume maximization neuron selection policy may include the processor 1401 being operative to execute the at least one machine executable instruction to: determine, for each neuron in the network layer to be pruned, a product of the importance value and the diversity value of the neuron as a feature vector for the neuron; select, from the neurons in the network layer to be pruned, a plurality of sets each including k neurons, where k is a predetermined positive integer; and calculate a volume of a parallelepiped formed by the feature vectors for the neurons included in each set, and select the set having the largest volume as the neurons to be retained.

Here, the processor 1401 being operative to execute the at least one machine executable instruction to select, from the network layer to be pruned, the neurons to be retained based on the importance values and diversity values of the neurons in the network layer to be pruned in accordance with the volume maximization neuron selection policy may include the processor 1401 being operative to execute the at least one machine executable instruction to: determine, for each neuron in the network layer to be pruned, a product of the importance value and the diversity value of the neuron as a feature vector for the neuron; and select, from the neurons in the network layer to be pruned, k neurons as the neurons to be retained by using a greedy method.

Here, the processor 1401 may be further operative to execute the at least one machine executable instruction to: adjust, for each network layer, starting with the pruned network layer, connecting weights between neurons in the network layer and neurons in its next network layer in accordance with a weight fusion policy.

Here, the processor 1401 may be further operative to execute the at least one machine executable instruction to: train the neural network having the weights adjusted, by using predetermined training data.

Based on the same concept as the above method, a storage medium (which can be a non-volatile machine readable storage medium) is provided according to some embodiments of the present disclosure. The storage medium stores a computer program for neural network pruning. The computer program includes codes configured to: determine importance values of neurons in a network layer to be pruned based on activation values of the neurons; determine a diversity value of each neuron in the network layer to be pruned based on connecting weights between the neuron and neurons in a next network layer; select, from the network layer to be pruned, neurons to be retained based on the importance values and diversity values of the neurons in the network layer to be pruned in accordance with a volume maximization neuron selection policy; and prune the other neurons from the network layer to be pruned to obtain a pruned network layer.

Based on the same concept as the above method, a computer program is provided according to an embodiment of the present disclosure. The computer program includes codes for neural network pruning, the codes being configured to:

determine importance values of neurons in a network layer to be pruned based on activation values of the neurons; determine a diversity value of each neuron in the network layer to be pruned based on connecting weights between the neuron and neurons in a next network layer; select, from the network layer to be pruned, neurons to be retained based on the importance values and diversity values of the neurons in the network layer to be pruned in accordance with a volume maximization neuron selection policy; and prune the other neurons from the network layer to be pruned to obtain a pruned network layer.

With the method for neural network pruning according to the embodiments of the present disclosure, first, for each neuron in a network layer to be pruned, an importance value of the neuron is determined based on an activation value of the neuron and a diversity value of the neuron based on connecting weights between the neuron and neurons in a next network layer. Then, neurons to be retained are selected from the network layer to be pruned based on the importance values and diversity values of the neurons in the network layer to be pruned in accordance with a volume maximization neuron selection policy. In the solutions according to the present disclosure, an importance value of a neuron reflects a degree of impact the neuron has on an output result from the neural network, and a diversity of a neuron reflects its expression capability. Hence, the neurons selected in accordance with the volume maximization neuron selection policy have greater contributions to the output result from the neural network and higher expression capabilities, while the pruned neurons are neurons having smaller contributions to the output result from the neural network and lower expression capabilities. Accordingly, when compared with the original neural network, the pruned neural network may achieve good compression and acceleration effects while having little accuracy loss. Therefore, the pruning method according to the embodiment of the present disclosure may achieve good compression and acceleration effects while maintaining the accuracy of the neural network.

The basic principles of the present disclosure have been described above with reference to the embodiments. However, it can be appreciated by those skilled in the art that all or any of the steps or components of the method or apparatus according to the present disclosure can be implemented in hardware, firmware, software or any combination thereof in any computing device (including a processor, a storage medium, etc.) or a network of computing devices. This can be achieved by those skilled in the art using their basic programing skills based on the description of the present disclosure.

It can be appreciated by those skilled in the art that all or part of the steps in the method according to the above embodiment can be implemented in hardware following instructions of a program. The program can be stored in a computer readable storage medium. The program, when executed, may include one or any combination of the steps in the method according to the above embodiment.

Further, the functional units in the embodiments of the present disclosure can be integrated into one processing module or can be physically separate, or two or more units can be integrated into one module. Such integrated module can be implemented in hardware or software functional units. When implemented in software functional units and sold or used as a standalone product, the integrated module can be stored in a computer readable storage medium.

It can be appreciated by those skilled in the art that the embodiments of the present disclosure can be implemented as a method, a system or a computer program product. The present disclosure may include pure hardware embodiments, pure software embodiments and any combination thereof. Also, the present disclosure may include a computer program product implemented on one or more computer readable storage mediums (including, but not limited to, magnetic disk storage and optical storage) containing computer readable program codes.

The present disclosure has been described with reference to the flowcharts and/or block diagrams of the method, device (system) and computer program product according to the embodiments of the present disclosure. It can be appreciated that each process and/or block in the flowcharts and/or block diagrams, or any combination thereof, can be implemented by computer program instructions. Such computer program instructions can be provided to a general computer, a dedicated computer, an embedded processor or a processor of any other programmable data processing device to constitute a machine, such that the instructions executed by a processor of a computer or any other programmable data processing device can constitute means for implementing the functions specified by one or more processes in the flowcharts and/or one or more blocks in the block diagrams.

These computer program instructions can also be stored in a computer readable memory that can direct a computer or any other programmable data processing device to operate in a particular way. Thus, the instructions stored in the computer readable memory constitute a manufacture including instruction means for implementing the functions specified by one or more processes in the flowcharts and/or one or more blocks in the block diagrams.

These computer program instructions can also be loaded onto a computer or any other programmable data processing device, such that the computer or the programmable data processing device can perform a series of operations/steps to achieve a computer-implemented process. In this way, the instructions executed on the computer or the programmable data processing device can provide steps for implementing the functions specified by one or more processes in the flowcharts and/or one or more blocks in the block diagrams.

While the embodiments of the present disclosure have described above, further alternatives and modifications can be made to these embodiments by those skilled in the art in light of the basic inventive concept of the present disclosure. The claims as attached are intended to cover the above embodiments and all these alternatives and modifications that fall within the scope of the present disclosure.

Obviously, various modifications and variants can be made to the present disclosure by those skilled in the art without departing from the spirit and scope of the present disclosure. Therefore, these modifications and variants are to be encompassed by the present disclosure if they fall within the scope of the present disclosure as defined by the claims and their equivalents.

1. A method for neural network pruning, comprising:
determining importance values of neurons in a network layer to be pruned based on activation values of the neurons;
determining a diversity value of each neuron in the network layer to be pruned based on connecting weights between the neuron and neurons in a next network layer;
selecting, from the network layer to be pruned, neurons to be retained based on the importance values and diversity values of the neurons in the network layer to be pruned in accordance with a volume maximization neuron selection policy; and
pruning the other neurons from the network layer to be pruned to obtain a pruned network layer.

2. The method of claim 1, wherein said determining the importance values of the neurons in the network layer to be pruned based on the activation values of the neurons comprises:
obtaining an activation value vector for each neuron in the network layer to be pruned by performing a forward operation on input data using the neural network;
calculating a variance of the activation value vector for each neuron;
obtaining a neuron variance importance vector for the network layer to be pruned based on the variances for the respective neurons; and
obtaining the importance value of each neuron by normalizing the variance for the neuron based on the neuron variance importance vector.

3. The method of claim 2, wherein the variance for the neuron is normalized as:
$${q}_{i} = \frac{{q}_{i} - min ( Q )}{max ( Q ) - min ( Q )} , for Q = {[ {q}_{1} , {q}_{2} , … , {q}_{{n}_{l}} ]}^{T}$$
where qᵢ is the variance of the activation value vector for the i-th neuron in the network layer to be pruned, and Q is the neuron variance importance vector for the network layer to be pruned.

4. The method of claim 1, wherein said determining the diversity value of each neuron in the network layer to be pruned based on the connecting weights between the neuron and the neurons in the next network layer comprises:
creating, for each neuron in the network layer to be pruned, a weight vector for the neuron based on the connecting weights between the neuron and the neurons in the next network layer, and determining a direction vector of the weight vector as the diversity value of the neuron.

5. The method of claim 1, wherein said selecting, from the network layer to be pruned, the neurons to be retained based on the importance values and diversity values of the neurons in the network layer to be pruned in accordance with the volume maximization neuron selection policy comprises:
determining, for each neuron in the network layer to be pruned, a product of the importance value and the diversity value of the neuron as a feature vector for the neuron;
selecting, from the neurons in the network layer to be pruned, a plurality of sets each including k neurons, where k is a predetermined positive integer; and
calculating a volume of a parallelepiped formed by the feature vectors for the neurons included in each set, and selecting the set having the largest volume as the neurons to be retained.

6. The method of claim 1, wherein said selecting, from the network layer to be pruned, the neurons to be retained based on the importance values and diversity values of the neurons in the network layer to be pruned in accordance with the volume maximization neuron selection policy comprises:
determining, for each neuron in the network layer to be pruned, a product of the importance value and the diversity value of the neuron as a feature vector for the neuron; and
selecting, from the neurons in the network layer to be pruned, k neurons as the neurons to be retained by using a greedy method.

7. The method of claim 6, wherein said selecting, from the neurons in the network layer to be pruned, k neurons as the neurons to be retained by using the greedy method comprises:
initializing a set of neurons as a null set;
creating a feature matrix from the feature vectors for the neurons in the network layer to be pruned; and
selecting the k neurons by performing the following steps in a plurality of cycles:
selecting, from a feature matrix for a current cycle of selection, a feature vector having the largest length and adding the neuron corresponding to the feature vector having the largest length to the set of neurons; and
determining whether a number of neurons in the set of neurons has reached k, and if so, terminating the cycles; or otherwise removing, from the feature matrix selected in the current cycle, a projection of the feature vector having the largest length onto each of the other feature vectors, to obtain a feature matrix for a next cycle of selection and proceeding with the next cycle.

8. The method of claim 1, further comprising, subsequent to obtaining the pruned network layer:
adjusting, for each network layer, starting with the pruned network layer, connecting weights between neurons in the network layer and neurons in its next network layer in accordance with a weight fusion policy.

9. The method of claim 8, further comprising:
training the neural network having the weights adjusted, by using predetermined training data.

10. An apparatus for neural network pruning, comprising:
an importance value determining unit configured to determine importance values of neurons in a network layer to be pruned based on activation values of the neurons;
a diversity value determining unit configured to determine a diversity value of each neuron in the network layer to be pruned based on connecting weights between the neuron and neurons in a next network layer;
a neuron selecting unit configured to select, from the network layer to be pruned, neurons to be retained based on the importance values and diversity values of the neurons in the network layer to be pruned in accordance with a volume maximization neuron selection policy; and
a pruning unit configured to prune the other neurons from the network layer to be pruned to obtain a pruned network layer.

11. The apparatus of claim 10, wherein the importance value determining unit comprises:
an activation value vector determining module configured to obtain an activation value vector for each neuron in the network layer to be pruned by performing a forward operation on input data using the neural network;
a calculating module configured to calculate a variance of the activation value vector for each neuron;
a neuron variance importance vector determining module configured to obtain a neuron variance importance vector for the network layer to be pruned based on the variances for the respective neurons; and
an importance value determining module configured to obtain the importance value of each neuron by normalizing the variance for the neuron based on the neuron variance importance vector.

12. The apparatus of claim 10, wherein the diversity value determining unit is configured to:
create, for each neuron in the network layer to be pruned, a weight vector for the neuron based on the connecting weights between the neuron and the neurons in the next network layer, and determine a direction vector of the weight vector as the diversity value of the neuron.

13. The apparatus of claim 10, wherein the neuron selecting unit comprises:
a first feature vector determining module configured to determine, for each neuron in the network layer to be pruned, a product of the importance value and the diversity value of the neuron as a feature vector for the neuron;
a set module configured to select, from the neurons in the network layer to be pruned, a plurality of sets each including k neurons, where k is a predetermined positive integer; and
a first selecting module configured to calculate a volume of a parallelepiped formed by the feature vectors for the neurons included in each set, and select the set having the largest volume as the neurons to be retained.

14. The apparatus of claim 10, wherein the neuron selecting unit comprises:
a second feature vector determining module configured to determine, for each neuron in the network layer to be pruned, a product of the importance value and the diversity value of the neuron as a feature vector for the neuron; and
a second selecting module configured to select, from the neurons in the network layer to be pruned, k neurons as the neurons to be retained by using a greedy method.

15. The apparatus of claim 10, further comprising:
a weight adjusting unit configured to adjust, for each network layer, starting with the pruned network layer, connecting weights between neurons in the network layer and neurons in its next network layer in accordance with a weight fusion policy.

16. The apparatus of claim 15, further comprising:
a training unit configured to train the neural network having the weights adjusted, by using predetermined training data.

17. An apparatus for neural network pruning, comprising a processor and at least one memory storing at least one machine executable instruction, the processor being operative to execute the at least one machine executable instruction to:
determine importance values of neurons in a network layer to be pruned based on activation values of the neurons;
determine a diversity value of each neuron in the network layer to be pruned based on connecting weights between the neuron and neurons in a next network layer;
select, from the network layer to be pruned, neurons to be retained based on the importance values and diversity values of the neurons in the network layer to be pruned in accordance with a volume maximization neuron selection policy; and
prune the other neurons from the network layer to be pruned to obtain a pruned network layer.

18. The apparatus of claim 17, wherein the processor being operative to execute the at least one machine executable instruction to determine the importance values of the neurons in the network layer to be pruned based on the activation values of the neurons comprises the processor being operative to execute the at least one machine executable instruction to:
obtain an activation value vector for each neuron in the network layer to be pruned by performing a forward operation on input data using the neural network;
calculate a variance of the activation value vector for each neuron;
obtain a neuron variance importance vector for the network layer to be pruned based on the variances for the respective neurons; and
obtain the importance value of each neuron by normalizing the variance for the neuron based on the neuron variance importance vector.

19. The apparatus of claim 17, wherein the processor being operative to execute the at least one machine executable instruction to determine the diversity value of each neuron in the network layer to be pruned based on the connecting weights between the neuron and the neurons in the next network layer comprises the processor being operative to execute the at least one machine executable instruction to:
create, for each neuron in the network layer to be pruned, a weight vector for the neuron based on the connecting weights between the neuron and the neurons in the next network layer, and determine a direction vector of the weight vector as the diversity value of the neuron.

20. The apparatus of claim 17, wherein the processor being operative to execute the at least one machine executable instruction to select, from the network layer to be pruned, the neurons to be retained based on the importance values and diversity values of the neurons in the network layer to be pruned in accordance with the volume maximization neuron selection policy comprises the processor being operative to execute the at least one machine executable instruction to:
determine, for each neuron in the network layer to be pruned, a product of the importance value and the diversity value of the neuron as a feature vector for the neuron;
select, from the neurons in the network layer to be pruned, a plurality of sets each including k neurons, where k is a predetermined positive integer; and
calculate a volume of a parallelepiped formed by the feature vectors for the neurons included in each set, and select the set having the largest volume as the neurons to be retained.

21. The apparatus of claim 17, wherein the processor being operative to execute the at least one machine executable instruction to select, from the network layer to be pruned, the neurons to be retained based on the importance values and diversity values of the neurons in the network layer to be pruned in accordance with the volume maximization neuron selection policy comprises the processor being operative to execute the at least one machine executable instruction to:
determine, for each neuron in the network layer to be pruned, a product of the importance value and the diversity value of the neuron as a feature vector for the neuron; and
select, from the neurons in the network layer to be pruned, k neurons as the neurons to be retained by using a greedy method.

22. The apparatus of claim 17, wherein the processor is operative to execute the at least one machine executable instruction to:
adjust, for each network layer, starting with the pruned network layer, connecting weights between neurons in the network layer and neurons in its next network layer in accordance with a weight fusion policy.

23. The apparatus of claim 22, wherein the processor is operative to execute the at least one machine executable instruction to:
train the neural network having the weights adjusted, by using predetermined training data.
